(19) United States
(12) Patent Application Publication
(10) Pub. No.: US 2026/0091534 A1
(43) Pub. Date: Apr. 2, 2026

(54) SYSTEMS AND METHODS FOR TREATING CONSTRUCTION AGGREGATE

(71) Applicant: CODE Project Enterprise Ltd., Vancouver (CA)

(72) Inventor: David BALKANYI, Vancouver (CA)

(21) Appl. No.: 19/348,667

(22) Filed: Oct. 2, 2025

Related U.S. Application Data
(60) Provisional application No. 63/702,582, filed on Oct. 2, 2024.

(51) Int. Cl. B28C 7/04; B28C 7/00

(52) U.S. Cl. CPC B28C 7/0418; B28C 7/0038

(57) ABSTRACT

A system for treating aggregate for use in a concrete mixture comprising an intermediary hopper for receiving the aggregate, and an agent source in fluid communication with the intermediary hopper for applying a treatment agent to the aggregate deposited into the intermediary hopper. The treatment agent may be applied to the aggregate prior to the aggregate being used in a concrete hydration process. Method for treating aggregate for use in a concrete mixture comprising feedback control of the application of the treatment agent based at least on measured properties of the aggregate, the treatment agent, and/or the intermediary hopper. Method for treating aggregate for use in a concrete mixture comprising depositing and treating the aggregate as a plurality of batches to increase effective surface area for thermal exchange.

### REFERENCE TO RELATED APPLICATIONS

This application claims priority from, and for the purposes of United States, the benefit under 35 USC 119 in connection with, U.S. application No. 63/702582 filed 2 Oct. 2024, which is hereby incorporated herein by reference.

### FIELD

This invention relates to systems and methods for treating construction aggregate (also referred to as herein “aggregate” for brevity) for use in concrete mixing. Aspects of the invention relate to treating aggregate with a treatment agent in an intermediary hopper.

### BACKGROUND

Concrete is the most widely used building material in the world. Concrete is produced by mixing various ingredients together. The ingredients typically include at least water, cement, aggregate, and optionally admixtures. When the ingredients are mixed together, cement reacts with water to cause the mixture to set and harden. This process is referred to as the concrete hydration process. When the concrete hydration process completes, the mixture becomes cured concrete. The concrete hydration process is exothermic (i.e. the reaction between water and cement releases heat).

It is critical to control the temperature of the ingredients in the mixture given the exothermic nature of the hydration process. Temperatures exceeding or falling below certain threshold temperatures may reduce the quality of the concrete or disrupt the hydration process. For example, if the temperature exceeds an upper threshold due to excessive buildup of heat, there may be an increased risk of thermal cracking, suboptimal strength and durability of the concrete, and/or structural defects in the concrete. In another example, if the temperature falls below a lower threshold temperature, there may be an increased risk of delay or disruption to the setting and curing of the hydration process as well as an increased risk of freezing which may lead to cracking or permanent loss of concrete strength, and/or reduced durability and structural integrity.

Temperature control in the hydration process is critical in ready-mix concrete production. Ready-mix concrete is pre-mixed concrete made at a batching plant and subsequently delivered to an on-site location (e.g. a construction site) in a ready-to-use state. In contrast to central-mix concrete, where all ingredients are mixed at the plant, ready-mix concrete is often mixed during transport within a transporting vehicle (e.g. mixed in a rotating drum on a truck). As a result, the ready-mix concrete is more susceptible to the effect of the ambient environment during transport. Therefore, it is paramount that a temperature of the ready-mix concrete batch is controlled to a desired level prior to the ready-mix concrete batch departing the plant (i.e. to be transported to the on-site location) to account for the effect of ambient temperature during transport.

One of the challenges to ready-mix concrete in an environment of relatively high ambient temperature is to ensure that the temperature of the ready-mix concrete batch remains below a threshold temperature while the ready-mix concrete batch is transported from the batch plant to the on-site location. In some jurisdictions, the threshold temperature may be set by regulations.

Variations solutions have been proposed to control a temperature of a ready-mix batch. One conventional prior art solution for controlling the temperature of a concrete mixture (e.g. a ready-mix batch) is the use of chilled water in the concrete mixture. This technique utilizes the relatively high specific heat capacity of water to control the temperature of the ready-mix batch. However, use of chilled water is limited by the need to maintain the correct water-cement ratio in the mixture. If too much water is added, the resultant concrete may have reduced strength and durability. Consequently, using chilled water to cool concrete can only reduce the temperature by a limited amount, which might not be sufficient for an environment of relatively high temperature or large concrete pours where significant heat management is required. The cooling effect may also not be uniform throughout the mixture, leading to inconsistent setting and curing rates within the batch, which can affect the quality of the concrete. Lastly, the cooling effect of chilled water is typically short-lived, and the concrete can quickly heat up again during transport or placement in part due to the exothermic nature of the concrete hydration process.

Another conventional prior art solution for controlling the temperature of a concrete mixture (e.g. a ready-mix batch) is the addition of ice to the concrete mixture. This solution utilizes the concept of latent heat, which involves the heat energy absorbed or released during a phase change without a change in temperature. Ice cooling is particularly beneficial when a faster cooling rate is required. However, like chilled water, ice can only reduce the temperature by a limited amount, typically a limit of about 6-7 degrees Celsius. Consequently, the use of ice may not be sufficient in an environment of relatively high temperature. Additionally, ice cooling tends to be not uniform throughout the mixture resulting in significant temperature variance in the mixture. Furthermore, storing and handling ice is labour-intensive and adds significant costs to the concrete production process.

Another known solution for controlling the temperature of a concrete mixture (e.g. a ready-mix batch) is the use of liquid nitrogen (or “LN2” for brevity) for cooling the concrete mixture. LN2 is an extremely cold substance with a boiling point of −196 degrees Celsius. When LN2 is added to the concrete mix, it rapidly evaporates, absorbing a substantial amount of heat from the mixture. Compared to chilled water and ice, LN2 has the advantages of being applicable in comparatively large volume without affecting the chemical balance of the mixture, because evaporated LN2 (which is effectively nitrogen gas) largely disperses into the ambient air (about 78% of ambient air comprises nitrogen gas). In other words, LN2 can be applied to treat the mixture or parts of the mixture without affecting the mixture balance as water, ice, or a typical admixture would.

There are various techniques to apply LN2 to the concrete mix. One conventional prior art technique uses a dispensing head for dispensing LN2 onto aggregate being transported on a conveyor positioned below the dispensing head. The drawback of this technique is its imprecise control of the dispensing of LN2. The application of LN2 in such a manner is relatively ineffective and wasteful since a substantial amount of LN2 dispensed by the dispensing head vaporizes before coming into contact with the aggregate. Nitrogen in gaseous state may have 400% to 600% lower thermal conductivity coefficient than LN2, leading to suboptimal thermal exchange.

Another conventional prior art technique for applying LN2 specifically to a ready-mix concrete mix involves using specially made “lances” to inject LN2 into a rotating drum of a truck. The truck transports the ready-mix concrete mix from the plant to an on-site location. This technique has several limitations and safety hazards. First, the rotating drum may be damaged by thermal shock caused by the injection of LN2. The thermal shock is due to the steep thermal gradient between the temperature of the rotating drum (which could be 30 to 40 degrees Celsius in an environment of relatively high temperature) and the temperature of LN2 (which may be around −190 degrees Celsius). Moreover, injecting LN2 into the rotating drum requires significant time to achieve an average maximum cooling by about 2 degrees Celsius. The added time to achieve the desired temperature control lowers the turnaround time of the trucks, thus lowering profitability. Lastly, the lances require manual operation. Manually handling LN2 injection is a serious safety hazard due to the potential for splashing or spraying LN2 onto the operator causing cryogenic burns.

On the other hand, a challenge to ready-mix concrete in an environment of relatively low ambient temperature is to ensure that the temperature of the ready-mix concrete batch remains above a threshold temperature and/or remains below a threshold moisture level while the ready-mix concrete batch is being prepared and also during transport. The threshold temperature and the threshold moisture level may be a temperature and moisture level below which the risk of freezing or disruption of the concrete hydration process becomes material. In regions without solution for maintaining a threshold temperature/moisture on the lower end, concrete plants may have to cease operation when the ambient temperature is too low. This is financially costly for plants located in regions with long periods of relatively low temperatures.

There is a desire for systems and methods that improve upon prior art solutions and techniques of controlling the temperature of a concrete mix during the hydration process and/or ameliorate any of the drawbacks of the prior art solutions and techniques.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention has a number of aspects. These include, without limitation:
systems and methods for treating an aggregate for use in a concrete mixture in an intermediary hopper prior to a concrete hydration process;
systems and methods for treating an aggregate for use in a concrete mixture based on feedback control of control parameters based at least on measured properties of the aggregate prior to deposit into an intermediary hopper; and
systems and methods for treating an aggregate for use in a concrete mixture by batching aggregate mass in an intermediary hopper and treating batches of the aggregate mass to increase an effective area of thermal exchange.

One aspect of the invention provides a system for treating aggregate for use in a concrete mixture. The system comprises an intermediary hopper for receiving the aggregate and an agent source in fluid communication with the intermediary hopper for applying a treatment agent to the aggregate deposited into the intermediary hopper. The treatment agent may be applied to the aggregate prior to the aggregate being used in a concrete hydration process.

In some embodiments, the aggregate comprises a plurality of aggregate masses, the plurality of aggregate masses deposited into the intermediary hopper spaced apart in time as a plurality of aggregate mass batches and the treatment agent is applied to each of the plurality of aggregate mass batches such that an effective surface area for thermal exchange between the treatment agent and the aggregate with batching is greater than an effective surface area for thermal exchange between the treatment agent and the aggregate without batching.

In some embodiments, the system comprises a controller in data communication with one or more pressure sensors located proximate to an application site of the treatment agent to measure a pressure of the treatment agent at the application site, wherein the controller is configured to adjust a pressure of the treatment agent at the agent source based at least in part on the pressure of the agent measured at the application site.

In some embodiments, the pressure of the treatment agent at the agent source is adjusted such that the pressure of the treatment agent at the application site in a range of about 20 psi to about 120 psi, and preferably in a range of about 40 psi to about 100 psi.

In some embodiments, the system comprises a controller in data communication with a plurality of aggregate temperature sensors located proximate to the aggregate located in an aggregate source to measure local aggregate temperatures of a plurality of portions of the aggregate at the aggregate source, wherein the controller is configured to selectively and controllably apply the treatment agent to one or more portions of the plurality of portions of the aggregate deposited into the intermediary hopper based at least in part on the local aggregate temperatures of the plurality of portions of the aggregate measured at the aggregate source.

In some embodiments, the system comprises a controller in data communication with a plurality of aggregate moisture sensors located proximate to the aggregate located in an aggregate source to measure local aggregate moisture levels of a plurality of portions of the aggregate at the aggregate source, wherein the controller is configured to selectively and controllably apply the treatment agent to one or more portions of the plurality of portions of the aggregate deposited into the intermediary hopper based at least in part on the local aggregate moisture levels of the plurality of portions of the aggregate measured at the aggregate source.

In some embodiments, the system comprises a controller in data communication with one or more hopper temperature sensors located proximate to the intermediary hopper to measure a hopper temperature of the intermediary hopper wherein the controller is configured to apply the treatment agent to the intermediary hopper and/or to at least portions of the aggregate deposited into the intermediary hopper based at least in part on the measured hopper temperature.

In some embodiments, the treatment agent is applied to the intermediary hopper prior to any aggregate being deposited into the intermediary hopper.

In some embodiments, the treatment agent comprises a cryogenic agent and is applied to the intermediary hopper such that a thermal gradient between the intermediary hopper and the aggregate with the application of the treatment agent to the intermediary hopper is more steep than a thermal gradient between the intermediary hopper and the aggregate without the application of the treatment agent to the intermediary hopper.

In some embodiments, the application of the treatment agent to the aggregate regulates one or more properties of the aggregate, the one or more properties including at least one of: temperature and moisture.

In some embodiments, the treatment agent comprises a specialty gas.

In some embodiments, the specialty gas comprises purified nitrogen gas.

In some embodiments, the treatment agent comprises a cryogenic agent.

In some embodiments, the cryogenic agent comprises liquid nitrogen (LN2).

In some embodiments, the system comprises a controller configured to controllably apply the treatment agent to the aggregate according to one or more control parameters, the one or more control parameters including at least one of: a type of the treatment agent to be applied, a pressure of the treatment agent, a delivery method of the treatment agent, a droplet size of the treatment agent, and a spraying pattern of the treatment agent.

In some embodiments, the aggregate comprises plural portions of different types of aggregate materials and the one or more control parameters is based at least in part on the types of aggregate materials receiving the application of the treatment agent.

In some embodiments, the one or more control parameters is based at least in part on a mass of the portion of aggregate materials receiving the application of the treatment agent.

In some embodiments, the one or more control parameters are based at least in part on a temperature of the portion of aggregate materials receiving the application of the treatment agent.

In some embodiments, the one or more control parameters are based at least in part on a moisture level of the portion of aggregate materials receiving the application of the treatment agent.

In some embodiments, the treatment agent comprises a cryogenic agent and the cryogenic agent is applied to water at a water source for use in the concrete mixture prior to the concrete hydration process, thereby regulating a temperature of the water at the water source.

In some embodiments, the intermediary hopper is located in a controlled environment wherein at least one of temperature, humidity, exposure to light, and air circulation, is controlled.

Another aspect of the invention provides a method for treating aggregate to be used in a concrete mixture, the method comprising the steps of: measuring one or more properties of the aggregate, depositing the aggregate into an intermediary hopper, and applying a treatment agent to the aggregate according to one or more control parameters, the one or more control parameters based at least in part on the one or more measured properties of the aggregate.

In some embodiments, measuring the one or more properties of the aggregate comprises measuring at least one of: temperature and moisture level.

In some embodiments, the one or more control parameters comprise at least one of: a type of the treatment agent to be applied, a pressure of the treatment agent, a delivery method of the treatment agent, a droplet size of the treatment agent, and a spraying pattern of the treatment agent.

In some embodiments, the treatment agent comprises a cryogenic agent and the one or more measured properties of the aggregate include at least a temperature of the aggregate.

In some embodiments, the cryogenic agent comprises LN2.

In some embodiments, the treatment agent comprises a specialty gas and the one or more measured properties of the aggregate include at least a moisture level of the aggregate.

In some embodiments, the specialty gas comprises purified nitrogen gas.

In some embodiments, the method further comprises the step of measuring one or more properties of the intermediary hopper wherein the one or more control parameters is based at least in part on the one or more measured properties of the intermediary hopper.

In some embodiments, the one or more measured properties of the intermediary hopper comprises at least a temperature of the intermediary hopper.

Another aspect of the invention provides a method for treating aggregate to be used in a concrete mixture, the method comprising the steps of: depositing a plurality of aggregate masses into an intermediary hopper, each aggregate mass deposited into the intermediary hopper spaced apart in time as an aggregate mass batch; and applying a treatment agent to each of the plurality of aggregate mass batches such that an effective surface area for thermal exchange between the treatment agent and the aggregate with batching is greater than an effective surface area for thermal exchange between the treatment agent and the aggregate without batching.

In some embodiments, the method further comprises the step of measuring one or more properties of each of the plurality of aggregate masses prior to depositing the corresponding aggregate mass into the intermediary hopper, wherein applying the treatment agent to the corresponding aggregate mass batch comprises applying the treatment agent to the corresponding aggregate mass batch according to one or more control parameters based at least in part on the one or more measured properties of the corresponding aggregate mass.

In some embodiments, the one or more measured properties of the corresponding aggregate mass comprises at least one of: a temperature of the aggregate mass and a moisture level of the aggregate mass.

In some embodiments, the one or more control parameters comprises at least one of: a type of the treatment agent to be applied, a pressure of the treatment agent, a delivery method of the treatment agent, a droplet size of the treatment agent, and a spraying pattern of the treatment agent.

In some embodiments, the treatment agent comprises a cryogenic agent and the one or more measured properties of the aggregate include at least a temperature of the aggregate.

In some embodiments, the cryogenic agent comprises LN2.

In some embodiments, the treatment agent comprises a specialty gas and the one or more measured properties of the aggregate include at least a moisture level of the aggregate.

In some embodiments, the specialty gas comprises purified nitrogen gas.

In some embodiments, the method comprises the step of measuring one or more properties of the intermediary hopper wherein the one or more control parameters are based at least in part on the one or more measured properties of the intermediary hopper.

In some embodiments, the one or more measured properties of the intermediary hopper comprises at least a temperature of the intermediary hopper.

Another aspect of the invention provides a system for treating aggregate for use in a concrete mixture. The system comprises an intermediary hopper for receiving the aggregate from an aggregate source, an agent source in fluid communication with the intermediary hopper for applying a treatment agent to the aggregate deposited into the intermediary hopper, and a controller in data communication with one or more sensors configured to measure one or more properties of at least one of: the aggregate, the intermediary hopper, and the treatment agent, the controller configured to controllably apply the treatment agent to the aggregate based on one or more control parameters. The one or more control parameters are based at least on the one or more measured properties.

In some embodiments, the aggregate is deposited into the intermediary hopper spaced apart in time as a plurality of batches and the treatment agent is applied to one or more of the plurality of batches.

In some embodiments, an effective surface area for thermal exchange between the treatment agent and the aggregate deposited as the plurality of batches is greater than an effective surface area for thermal exchange between the treatment agent and the aggregate without batching.

In some embodiments, the system comprises one or more agent applicators configured to apply the treatment agent to the aggregate wherein the one or more sensors comprise one or more pressure sensors located proximate to the one or more agent applicators for measuring a pressure of the treatment agent, and the controller is configured to adjust a pressure of the treatment agent at the agent source based at least in part on the measured pressure of the treatment agent.

In some embodiments, the system comprises a plurality of aggregate temperature sensors in data communication with the controller and configured to measure local aggregate temperatures of a plurality of portions of the aggregate at the aggregate source, wherein the controller is configured to selectively and controllably apply the treatment agent to one or more portions of the plurality of portions of the aggregate deposited into the intermediary hopper based at least in part on the measured local aggregate temperatures of the plurality of portions of the aggregate.

In some embodiments, the system comprises a plurality of aggregate moisture sensors in data communication with the controller and configured to measure local aggregate moisture levels of a plurality of portions of the aggregate at the aggregate source, wherein the controller is configured to selectively and controllably apply the treatment agent to one or more portions of the plurality of portions of the aggregate deposited into the intermediary hopper based at least in part on the measured local aggregate moisture levels of the plurality of portions of the aggregate.

In some embodiments, the system comprises one or more hopper temperature sensors in data communication with the controller and configured to measure a hopper temperature of the intermediary hopper wherein the controller is configured to apply the treatment agent to the intermediary hopper and/or to at least portions of the aggregate deposited into the intermediary hopper based at least in part on the measured hopper temperature.

In some embodiments, at least some of the treatment agent is applied to the intermediary hopper prior to any aggregate being deposited into the intermediary hopper.

In some embodiments, the treatment agent is applied to the intermediary hopper such that a thermal gradient between the intermediary hopper and the aggregate with the application of the treatment agent to the intermediary hopper is more steep than a thermal gradient between the intermediary hopper and the aggregate without the application of the treatment agent to the intermediary hopper.

In some embodiments, the application of the treatment agent to the aggregate regulates one or more properties of the aggregate, the one or more properties including at least one of: temperature and moisture.

In some embodiments, the treatment agent comprises a specialty gas.

In some embodiments, the specialty gas comprises purified nitrogen gas.

In some embodiments, the treatment agent comprises a cryogenic agent.

In some embodiments, the cryogenic agent comprises liquid nitrogen (LN2).

In some embodiments, the one or more control parameters comprises at least one of: a type of the treatment agent to be applied, a pressure of the treatment agent, a delivery method of the treatment agent, a droplet size of the treatment agent, and a spraying pattern of the treatment agent.

In some embodiments, the aggregate comprises plural portions of different types of aggregate materials and the one or more control parameters are based at least in part on the types of aggregate materials receiving the application of the treatment agent.

In some embodiments, the one or more control parameters are based at least in part on mass, temperature and/or moisture level of the portion of aggregate materials receiving the application of the treatment agent.

Another aspect of the invention provides a method for applying a treatment agent to aggregate to be used in a concrete mixture. The method comprises the steps of depositing the aggregate into an intermediary hopper, measuring one or more properties of at least one of: the aggregate, the treatment agent, and the intermediary hopper and, applying the treatment agent to the aggregate according to one or more control parameters, the one or more control parameters based at least in part on the one or more measured properties.

Another aspect of the invention provides a method for treating aggregate to be used in a concrete mixture. The method comprises the steps of depositing the aggregate into an intermediary hopper spaced apart in time as a plurality of batches and, applying a treatment agent to one or more of the plurality of batches such that an effective surface area for thermal exchange between the treatment agent and the aggregate deposited as the plurality of batches is greater than an effective surface area for thermal exchange between the treatment agent and the aggregate without batching.

In some embodiments, the method comprises measuring one or more properties of at least some of the plurality of aggregate masses prior to depositing the plurality of aggregate masses into the intermediary hopper, wherein applying the treatment agent to the one or more of the plurality of batches comprises applying the treatment agent to the one or more of the plurality of batches according to one or more control parameters, the one or more control parameters based at least in part on the one or more measured properties.

It is emphasized that the invention relates to all combinations of the above features, even if these are recited in different claims.

Further aspects and example embodiments are illustrated in the accompanying drawings and/or described in the following description.

### BRIEF DESCRIPTION OF THE DRAWINGS

1The accompanying drawings illustrate non-limiting example embodiments of the invention.

FIG. 1 a schematic diagram depicting a system for treating aggregate for use in a concrete mix according to an example embodiment.

FIG. 2 is a schematic diagram of a system for treating aggregate for use in a concrete mix according to another example embodiment.

FIG. 3 is a flowchart of a method for treating aggregate for use in a concrete mix according to an example embodiment.

FIG. 4 is a flowchart of a method for treating aggregate for use in a concrete mix according to another example embodiment.

### DETAILED DESCRIPTION

Throughout the following description, specific details are set forth in order to provide a more thorough understanding of the invention. However, the invention may be practiced without these particulars. In other instances, well-known elements have not been shown or described in detail to avoid unnecessarily obscuring the invention. Accordingly, the specification and drawings are to be regarded in an illustrative, rather than a restrictive sense.

One aspect of the invention described herein provides systems for treating aggregate for use in a concrete mixture. The system comprises an intermediary hopper for receiving the aggregate and an agent source in fluid communication with the intermediary hopper for applying a treatment agent to the aggregate deposited into the intermediary hopper. The treatment agent may be applied to the aggregate prior to the aggregate being used in a concrete hydration process. The aggregate may comprise a plurality of aggregate masses. The plurality of aggregate masses may be deposited into the intermediary hopper spaced apart in time as a plurality of aggregate mass batches and the treatment agent is applied to each of the plurality of aggregate mass batches such that an effective surface area for thermal exchange between the treatment agent and the aggregate with batching is greater than an effective surface area for thermal exchange between the treatment agent and the aggregate without batching. The system may comprise a controller in data communication with one or more pressure sensors located proximate to an application site of the treatment agent to measure a pressure of the treatment agent at the application site, wherein the controller is configured to adjust a pressure of the treatment agent at the agent source based at least in part on the pressure of the agent measured at the application site.

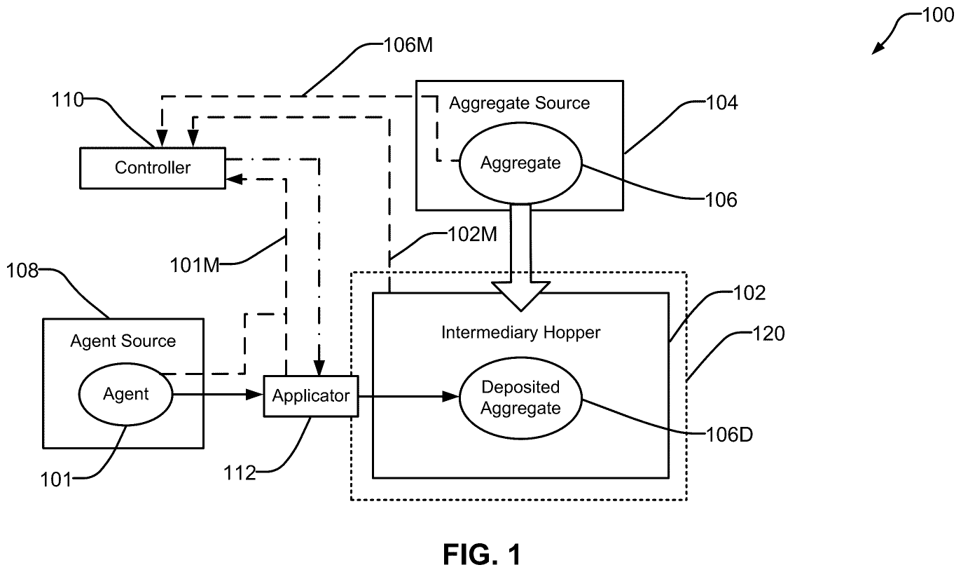

FIG. 1 is a schematic diagram depicting a system 100 for treating aggregate for use in a concrete mixture according to an example embodiment. System 100 may be applied to perform any one or more of the methods described herein (e.g. methods 300, 400, etc.).

System 100 comprises an intermediary hopper 102 for receiving (indicated by a solid white arrow in FIG. 1) aggregate 106 from an aggregate source 104. As used herein, “aggregate” refers to natural or manufactured particulate materials (fine and/or coarse) such as sand, gravel, crushed stone or rocks, and any industrially derived particles suitable for incorporate into a concrete mix. Aggregate 106 deposited into intermediary hopper 102 is referred to as deposited aggregate 106D. Intermediary hopper 102 is optionally located in a controlled environment 120. Controlled environment 120 may be any environment in which at least one environmental parameter is controlled relative to an ambient environment. Environmental parameters that may be controlled in environment 120 may include, but are not limited to: temperature, humidity, exposure to light, air circulation, etc.

Intermediary hopper 102 may comprise any suitable hopper(s). In some embodiments, intermediary hopper 102 is shaped to define a chamber for receiving and storing materials (e.g. deposited aggregate 106D). In some embodiments, intermediary hopper 102 comprises a dispensing mechanism for dispensing the materials stored in the chamber in a controllable manner. Intermediary hopper 102 may comprise any suitable dispensing mechanism for dispensing the materials stored in the chamber. The dispensing mechanism may include, but are not limited to, one or more of vibratory feeders, screw conveyors, rotary valves, etc. In some embodiments, the materials from intermediary hopper 102 are dispensed onto a conveyor to be transported from the hopper to other location(s).

In some embodiments, intermediary hopper 102 comprises a mixing module for mixing the materials received and stored in the chamber. The mixing mechanism may comprise any suitable mixing mechanism. The mixing mechanism may include, but are not limited to, one or more of: agitation, vibration, fluidization, mechanical augers, etc.

Intermediary hopper 102 may be made of any suitable materials. In some embodiments, intermediary hopper 102 is made of a material with relatively high thermal conductivity. In some embodiments, intermediary hopper 102 is made, at least in part, of steel.

System 100 comprises an agent source 108 in fluid communication with intermediary hopper 102 for supplying a treatment agent 101 to agent applicators 112 where agent applicators 112 apply treatment agent 101 to deposited aggregate 106D in intermediary hopper 102. In some embodiments, treatment agent 101 is applied to deposited aggregate 106D prior to deposited aggregate 106D being used in a concrete hydration process (i.e. mixing deposited aggregate 106D with water, cement, admixture, etc.).

In some embodiments, the application of treatment agent 101 to deposited aggregate 106D regulates one or more properties of deposited aggregate 106D. In some embodiments, the one or more properties includes at least one of: temperature of deposited aggregate 106D and moisture level of deposited aggregate 106D.

Treatment agent 101 may comprise any suitable treatment agent(s). In some embodiments, treatment agent 101 comprises a specialty gas. In some embodiments, the specialty gas comprises purified nitrogen gas. In some embodiments, the purified nitrogen gas has a temperature in the range of about −40 degrees Celsius to about 80 degrees Celsius. In some embodiments, the specialty gas is applied to lower a moisture level of deposited aggregate 106D to lower the risk of deposited aggregate 106D freezing. In some embodiments, the specialty gas is applied to increase a temperature of deposited aggregate 106D to maintain the temperature of deposited aggregate 106D above a lower bound threshold temperature.

In some embodiments, treatment agent 101 comprises a cryogenic agent. In some embodiments, the cryogenic agent comprises liquid nitrogen (LN2). In some embodiments, the LN2 has a temperature in the range of about −150 degrees Celsius to about −200 degrees Celsius. In some embodiments, the cryogenic agent is applied to lower a temperature of deposited aggregate 106D to maintain the temperature of deposited aggregate 106D below an upper bound threshold temperature.

In some embodiments, system 100 comprises a controller 110 configured to control (indicated by dot-and-dash arrow in FIG. 1) agent applicators 112 to controllably apply treatment agent 101 to deposited aggregate 106 according to one or more control parameters. Agent applicator 112 may be located proximate to intermediary hopper 102 for applying treatment agent 101 to deposited aggregate 106D.

Agent applicator 112 may comprise any suitable devices for applying treatment agent 101. In some embodiments, agent applicator 112 comprises at least one of the following devices: dispensers, sprinklers, nozzles, vents, blowers, etc. In some embodiments, agent applicator 112 comprises a mechanism for applying treatment agent 101 in a pressurized manner. In some embodiments, agent applicator 112 applies treatment agent 101 at a pressure in a range of about 20 psi to about 120 psi, and preferably in a range of about 40 psi to about 100 psi.

In some embodiments, the one or more control parameters include at least one of: a delivery pressure of treatment agent 101, a delivery method of treatment agent 101, a droplet size of treatment agent 101 (if treatment agent 101 is liquid), and a spraying pattern of treatment agent 101. In some embodiments, the one or more control parameters are based at least on one or more properties of treatment agent 101. For example, the delivery method of treatment agent 101 may depend on the physical state of treatment agent 101 (e.g. liquid, gas, etc.) and/or on the type of treatment agent 101.

In some embodiments, aggregate 106 comprises a plurality of portions of different types of aggregate materials and the one or more control parameters are based at least in part on the types of aggregate materials 106 receiving the application of treatment agent 101. For example, the different types of aggregate materials may include sand, gravel, rocks of various sizes, etc., and the one or more of the control parameters, e.g., a droplet size and/or a spraying pattern of treatment agent 101, may be different for different types of aggregate material. For example, a finer droplet size of treatment agent 101 may be applied for sand compared to relatively larger droplet size of treatment agent 101 for rocks. In another example, the delivery pressure of treatment agent 101 may depend on the physical state of treatment agent 101 and/or the type of treatment agent 101 and/or the type of the aggregate material to be treated. For example, a delivery pressure of treatment agent 101 for sand may be lower compared to that of gravel or rocks.

In some embodiments, the one or more control parameters of controller 110 for applying treatment agent 101 via agent applicator 112 is based at least in part on feedback (illustrated as dashed lines in FIG. 1) from various components of system 100. In some embodiments, the feedback from various components of system 100 comprises one or more measured properties of the aggregate 106, the treatment agent 101, and/or the intermediary hopper 102 collected by one or more sensors located at various locations. The one or more sensors may comprise any suitable sensors, e.g., temperature sensors, moisture sensors, pressure sensors, etc.

In some embodiments, controlled application of treatment agent 101 by controller 110 via agent applicator 112 is based at least in part on aggregate measurements 106M collected at aggregate source 104. In some embodiments, aggregate measurements 106M comprise at least measurements of a temperature of aggregate 106 and/or measurements of a moisture level of aggregate 106 at aggregates source 104.

In some embodiments, controlled application of treatment agent 101 by controller 110 via agent applicator 112 is based at least in part on hopper measurements 102M collected at intermediary hopper 102. In some embodiments, hopper measurements 102M comprise at least measurements of a temperature and/or a moisture level of intermediary hopper 102.

In some embodiments, controlled application of treatment agent 101 by controller 110 via agent applicator 112 is based at least in part on treatment agent measurements 101M collected at agent applicator 112 and/or at agent source 108. In some embodiments, applicator measurements 101M comprise at least measurements of a pressure, temperature or moisture level of agent 101 applied at agent source 108 and/or applicator 112.

In some embodiments, one or more of the feedback measurements collected from various components of the system is updated in a continuous manner thereby enabling “real-time” monitoring and control of the application of treatment agent 101, e.g., updated every second or less, every tenth of a second or less, every hundredth of a second or less, or every millisecond or less, etc. In some embodiments, the “real-time” monitoring and control is facilitated by a human-machine interface (HMI), thereby enabling an operator to monitor and control treatment of deposited aggregate 106D through system 100.

Controller 110 may comprise any suitable general-purpose computers and/or processors or any similarly configured computing systems or processor(s) for monitoring the one or more feedback measurements and/or controlling the one or more control parameters of the application of treatment agent 101 and/or performing one or more of the methods described herein (e.g. methods 300, 400, etc.).

In some embodiments, treatment agent 101 is applied to intermediary hopper 102 to regulate one or more properties of intermediary hopper 102. In some embodiments, the one or more properties comprise one or more of: temperature, and moisture level of hopper 102. In some embodiments, treatment agent 101 is applied to intermediary hopper prior to any aggregate 106 being deposited into intermediary hopper 102.

In some embodiments, treatment agent 101 comprises a cryogenic agent and the application of treatment agent 101 to adjust (e.g. lower) a temperature of intermediary hopper 102 relative to the ambient temperature such that intermediary hopper 102 may serve as an additional thermal exchange interface for deposited aggregate 106D to regulate a temperature of deposited aggregate 106D.

In some embodiments, treatment agent 101 is applied to intermediary hopper 102 to lower the temperature of intermediary hopper 102 to below zero degrees Celsius. In a preferred embodiment, treatment agent 101 is applied to intermediary hopper 102 such that the temperature of intermediary hopper 102 is maintained between −10 degrees Celsius and −40 degrees Celsius.

In some embodiments, treatment agent 101 is applied to intermediary hopper 102 such that a thermal gradient between intermediary hopper 102 and deposited aggregate 106D with the application of treatment agent 101 to intermediary hopper 102 is more steep than a thermal gradient between intermediary hopper 102 and deposited aggregate 106D without the application of treatment agent 101 to intermediary hopper 102.

In some embodiments, treatment agent 101 comprises a cryogenic agent and the cryogenic agent is applied to a water source for use in the concrete mixture to thereby regulate a temperature of the water prior to the water being used in the concrete hydration process (i.e., being mixed with cement, aggregate, admixture, etc.).

System 100 of the FIG. 1 embodiment is illustrated to show one aggregate source 104, one intermediary hopper 102, one agent source 108, one controller 110, and one applicator 112. However, this is not necessary. System 100 may comprise any suitable number of aggregate source(s) 104, intermediary hopper(s) 102, agent source(s) 108, controller(s) 110, and applicator(s) 112. The FIG. 1 embodiment is for illustrative purpose only and is not to be interpreted in a restrictive manner.

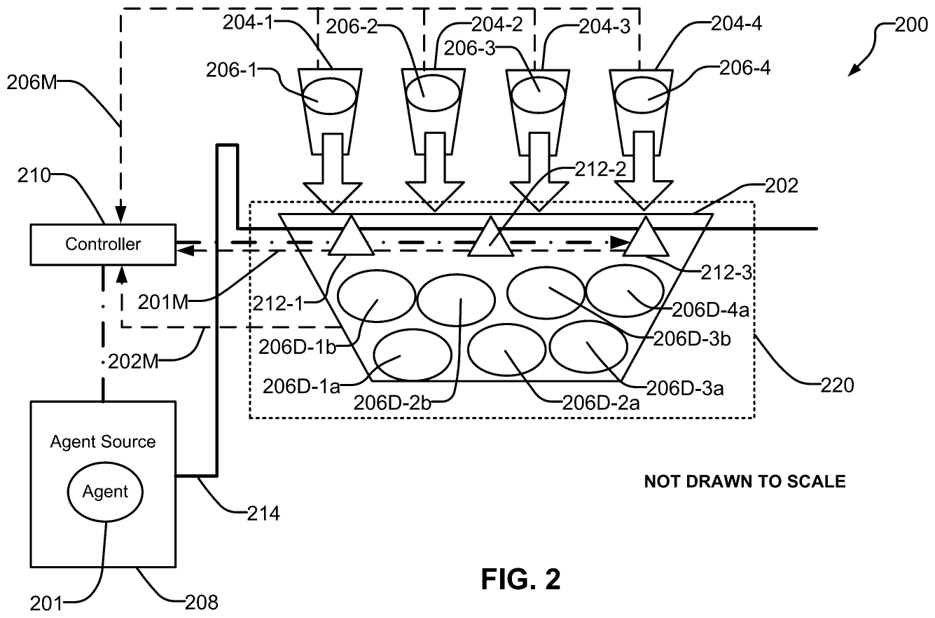

FIG. 2 is a schematic diagram of a system 200 for treating aggregate for use in a concrete mixture according to another example embodiment. System 200 is similar to system 100 described elsewhere herein, and unless explicitly described as being different or the context indicates a difference, system 200 may comprise any of the features of system 100 and vice versa. Features of system 200 that are similar to corresponding features of system 100 are labelled with the same reference numeral except that the features in system 200 are numbered in 200-series and the corresponding features in system 100 are numbered in 100-series. System 200 may be applied to perform any one or more of the methods described herein (e.g. methods 300, 400, etc.).

System 200 comprises an intermediary hopper 202 for receiving (indicated by solid arrows in FIG. 2) aggregate 206-1 to 206-4 from aggregate sources 204-1 to 204-4. Intermediary hopper 202 is optionally located in a controlled environment 220. Controlled environment 220 is similar to controlled environment 120, and for the sake of brevity, the description of controlled environment 220 will not be repeated here.

Aggregate deposited into intermediary hopper 202 is referred to as deposited aggregate 206D (e.g. deposited aggregate 206D-1 to 206D-4). System 200 of the FIG. 2 embodiment is shown to comprise multiple (i.e. four) separate aggregate sources 204-1 to 204-4 for supplying corresponding aggregate 206-1 to 206-4. However, this is not necessary. System 200 may comprise any suitable number of aggregate sources to supply any suitable number of corresponding aggregates.

In some embodiments, aggregate 206 comprises a plurality of different types of aggregate materials and at least some of aggregates 206-1 to 206-4 supplied by corresponding aggregate sources 204-1 to 204-4 comprise an aggregate material different from one another. For example, in a non-limiting example embodiment, aggregate 206-1 comprises rocks of about 20 mm diameter; aggregate 206-2 comprises rocks of about 15 mm diameter; and aggregates 206-3 and 206-4 each comprises sand.

In some embodiments, aggregate 206 is supplied to intermediary hopper 202 in a plurality of aggregate masses 206D-1a, 206D-1b, . . . , 206D-3b, 206D-4a, etc., spaced apart in time and deposited as a plurality of “batches”. For example, in the illustrated embodiment of FIG. 2, aggregate mass 206D-1a is deposited into intermediary hopper 202 at depositing time t₁, aggregate mass 206D-2a at depositing time t₂, aggregate mass 206D-3a at depositing time t₃, . . . , aggregate mass 206D-4a at depositing time t₇, where depositing times t₁, . . . , t₇ are different to one another and spaced apart in time (i.e. any two distinct depositing times are separated by a time interval).

However, it is not necessary that only one aggregate mass is deposited at any particular depositing time. In some embodiments, two or more aggregate masses may be deposited at the same depositing time. The aggregate mass(es) deposited at a given depositing time is(are) referred to as a “batch” herein in this application. For clarity, “batch” does not imply any specific geometrical relationship among the aggregate mass(es) in the hopper. For example, a subsequent “batch” does not have to be located in any particular geometric relationship relative to a prior batch upon depositing. Each batch can be deposited into any suitable location within the hopper with any suitable geometrical relationship relative to the batch(es) already deposited into the hopper. Any reference to “batch(es)” or “batching” in this application shall be understood to have the above-described meaning.

In some embodiments, treatment agent 201 supplied by an agent source 208 is applied to an aggregate mass batch deposited into intermediary hopper 202 at the corresponding depositing time before the next batch is deposited. In some embodiments, treatment agent 201 supplied by an agent source 208 is applied to at least one of the plurality of aggregate mass batches deposited into intermediary hopper 202 at the respective depositing times.

In some embodiments, treatment agent 201 is applied to the aggregate mass batches such that an effective surface area for thermal exchange between treatment agent 201 and deposited aggregate 206D with batching is greater than an effective surface area for thermal exchange between treatment agent 201 and deposited aggregate 206D without batching.

As used herein, the “effective surface area for thermal exchange” refers to the total surface areas available for facilitating heat transfer. For example, an aggregate mass broken into a plurality of batches has greater effective surface area of thermal exchange than the same aggregate mass in a single clump because the total surface areas of the aggregate mass available for facilitating heat transfer is greater in a plurality of batches compared to a single clump.

In the FIG. 2 embodiment, instead of depositing a plurality of aggregate masses from aggregate sources 204-1 to 204-4 as one single clump and applying treatment agent 201 to an outer surface of the single clump, aggregate masses from aggregate sources 204-1 to 204-4 can be deposited spaced apart in time as batches and treatment agent 201 can be applied to one or more batches (e.g. to an outer surface of the one or more batches).

Application of treatment agent 201 to one or more batches has the advantage of being able to facilitate more targeted heat transfer compared to applying treatment agent 201 to a single clump of aggregate mass, because batching allows treatment agent to be targeted at specific portions of the aggregate mass. Therefore, batching and application of treatment agent to batch(es) are able to achieve a much more uniform heat distribution with more precise temperature control in a more efficient manner of using the treatment agent. For example, a relatively higher volume of treatment agent 201 may be applied to batch(es) with a temperature further apart from a target temperature and a relatively lower volume of treatment agent may be applied to batch(es) with a temperature relatively close to the target temperature. Batching may also facilitate faster rate of heat transfer in deposited aggregate 106D when the sum of the surface area of the batches subject to the application of treatment agent is greater than the outer surface area of the single clump. The magnitude of the surface area subject to thermal exchange is proportional to the rate of heat transfer.

It is to be understood that batching as described above in relation to the FIG. 2 embodiment is also applicable to system 100 of the FIG. 1 embodiment.

System 200 comprises a controller 210 and agent applicators 212-1 to 212-3 in fluid communication with agent source 208 via conduit 214 for receiving treatment agent 201. Controller 210 is configured to control agent applicators 212-1 to 212-3 to controllably apply treatment agent 201 to deposited aggregate 206D and/or intermediary hopper 202 according to one or more control parameters.

System 200 of the FIG. 2 embodiment is shown to have three agent applicators 212. However, this is not necessary. FIG. 2 is schematic in nature and system 200 may comprise any suitable number of agent applicators 212. Agent applicators 212 may comprise any suitable mechanism for applying treatment agent 201. In some embodiments, agent applicators 212 comprise a mechanism for applying treatment agent 201 in a pressurized manner. In some embodiments, agent applicators 212 apply treatment agent 201 at a pressure in a range of about 20 psi to about 120 psi, and preferably in a range of about 40 psi to about 100 psi. In some embodiments, agent applicators 212 comprise at least one of: dispensers, sprinklers, nozzles, vents, blowers, etc. for applying treatment agent 201.

Agent applicators 212 may be arranged in any suitable geometrical relationship for applying treatment agent 201. In some embodiments, each of agent applicators 212-1 to 212-3 comprises a plurality of dispensing outlets arranged spaced apart linearly in a line (1D) or in a grid lattice geometry (2D).

In some embodiments, the one or more control parameters include at least one of: a delivery pressure of treatment agent 201, a delivery method of treatment agent 201, a droplet size of treatment agent 201 (if treatment agent 201 is liquid), and a spraying pattern of treatment agent 201. In some embodiments, the one or more control parameters are based at least on one or more properties of treatment agent 201. For example, the delivery method of treatment agent 201 may depend on the physical state of treatment agent 201 (e.g. liquid, gas, etc.) and/or on the type of treatment agent 201.

In some embodiments, aggregate 206 comprises a plurality of portions of different types of aggregate materials and the one or more control parameters are based at least in part on the types of aggregate materials 206 receiving the application of treatment agent 201. For example, the different types of aggregate materials may include sand, gravel, rocks of various sizes, etc., and the one or more of the control parameters, e.g., a droplet size and/or a spraying pattern of treatment agent 201, may be different for different types of aggregate material, e.g. finer droplet size of treatment agent 201 may be applied for sand compared to relatively larger droplet size of treatment agent 201 for rocks. In another example, the delivery pressure of treatment agent 201 may depend on the physical state of treatment agent 201 and/or the type of treatment agent 201 and/or the type of the aggregate material to be treated.

Similar to system 100, in some embodiments, the one or more control parameters of controller 210 for applying treatment agent 201 via agent applicators 212 is based at least in part on feedback (illustrated as dashed lines in FIG. 2) from various components of system 200. In some embodiments, the feedback from various components of system 200 comprises measurements collected by one or more sensors from system component(s) and/or aggregate 206 and/or treatment agent 201. The one or more sensors may comprise any suitable sensors, e.g., temperature sensors, moisture sensors, pressure sensors, etc.

In some embodiments, system 200 comprises one or more pressure sensors located proximate to applicators 212 applying treatment agent 201 to measure a pressure 201M of treatment agent 201 proximate to the applicators. In some embodiments, controller 210 is configured to adjust a pressure of treatment agent 201 at agent source 208 based at least in part on the pressure 201M of treatment agent 201 measured at the applicators.

In some embodiments, system 200 comprises a plurality of aggregate temperature sensors and/or a plurality of moisture sensors located proximate to aggregate 206 stored in aggregate sources 204 to measure local aggregate temperatures and/or moisture level 206M of a plurality of portions of aggregate 206 in aggregate sources 204. In some embodiments, after the plurality of portions of aggregate 206 is deposited to become a plurality of portions of deposited aggregate 206D, controller 210 is configured to selectively and controllably apply treatment agent 201 to the plurality of portions of deposited aggregate 206D based at least in part on the measured local aggregate temperatures and/or measured moisture level 206M collected from the corresponding plurality portions of aggregate 206 prior to depositing.

In some embodiments, system 200 comprises one or more hopper temperature and/or moisture sensors located proximate to intermediary hopper 202 to measure a hopper temperature and/or moisture 202M of intermediary hopper 202. In some embodiments, controller 210 is configured to apply treatment agent 201 to intermediary hopper 202 based at least in part on the measured hopper temperature and/or moisture 202M.

In some embodiments, one or more of the feedback from various components of the system is updated in a continuous fashion thereby enabling ongoing “real-time” monitoring and control of the application of treatment agent 201. In some embodiments, the “real-time” monitoring and control is facilitated by a human-machine interface (HMI), thereby enabling an operator to monitor and control treatment of deposited aggregate 206D through system 200.

Controller 210 may comprise any suitable general-purpose computers and/or processors or any similarly configured computing systems or processor(s) for controlling the one or more control parameters of the application of treatment agent 201 and/or for performing one or more of the methods described herein (e.g. methods 300, 400, etc.).

System 200 of the FIG. 2 embodiment is presented for non-limiting illustrative purposes only. System 200 may comprise any suitable number of aggregate source(s) 204, intermediary hopper(s) 202, agent source(s) 208, controller(s) 210, applicator(s) 212, and any suitable number of various types of sensors including, but not limited to, temperature sensors, pressure sensors, and moisture sensors.

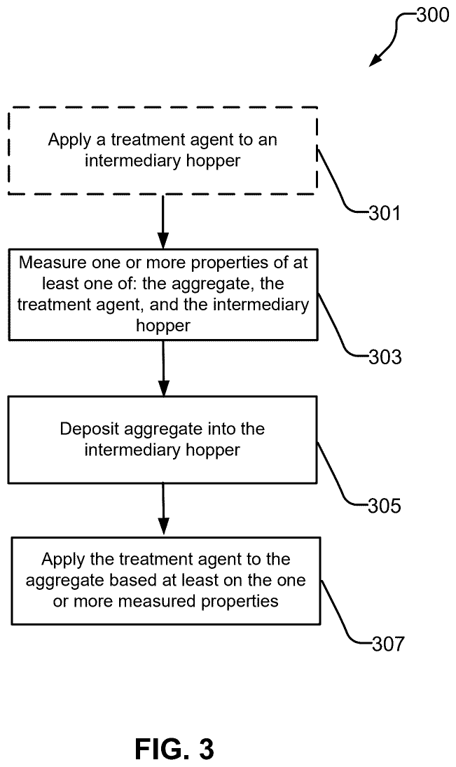

FIG. 3 is a flowchart of a method 300 of treating aggregate for use in a concrete mixture according to an example embodiment. Method 300 may be performed by any systems disclosed herein (e.g. systems 100, 200, etc.)

Method 300 begins block 301 which comprises the optional step of applying a treatment agent (e.g. treatment agent 101, 201) to an intermediary hopper (e.g. intermediary hopper 102, 202). Although shown as the first step in the flowchart of FIG. 3, optional step 301 may be applied at any step in method 300. For example, the application of the treatment agent to the intermediary hopper may be performed prior to the deposit of any aggregate in the intermediary hopper and/or may be performed at any time over the course of having the aggregate deposited into the intermediary hopper and/or while the aggregate is being mixed in the intermediary hopper.

In some embodiments, the treatment agent is applied to the intermediary hopper such that a thermal gradient between the intermediary hopper and the aggregate to be deposited with the application of the treatment agent to the intermediary hopper is more steep than a thermal gradient between the intermediary hopper and the aggregate to be deposited without the application of the treatment agent to the intermediary hopper. The more steep thermal gradient allows more heat to be transferred between the intermediary hopper and the deposited aggregate.

The application of the treatment agent to the intermediary hopper may facilitate treatment of the aggregate being deposited into the hopper. In a non-limiting example embodiment, the intermediary hopper can be cooled by a cryogenic agent or conditioned by a specialty gas to function as an additional thermal exchange interface for the aggregate to thereby assisting with regulating one or more properties of the aggregate mass (e.g., cooling/heating or controlling of a moisture level of the aggregate).

In addition, applying the treatment agent to the intermediary hopper may also lower the risk of thermal shock to the intermediary hopper due to exposure to treatment agent. For example, in a high-temperature environment where the treatment agent comprises a cryogenic agent, it may take some time for the cryogenic agent to reach the desired operational temperature (e.g. the cryogenic agent may absorb heat during transport from the agent source to the agent applicators). The cryogenic agent not at the desired operational temperature may be referred to as “start-up cryogenic agent”.

Instead of discarding the start-up cryogenic agent as waste, the start-up cryogenic agent may be applied to lower the temperature of the hopper prior to the deposit of any aggregate. The application of the start-up cryogenic agent to the intermediary hopper safely lowers a thermal gradient between the hopper and the operational cryogenic agent, because the temperature difference between the start-up cryogenic agent and the intermediary hopper is not as large as the temperature difference between the intermediary hopper and operational cryogenic agent. The application of the start-up cryogenic agent to the intermediary hopper reduces the temperature difference between the intermediary hopper and the operational cryogenic agent. Consequently, when the operational cryogenic agent is subsequently applied to the aggregate mass and incidentally impinges on the intermediary hopper, the risk of thermal shock to the intermediary hopper is reduced.

In a non-limiting example embodiment, the treatment agent comprises LN2. In some circumstances, upon start-up of the system (e.g. systems 100, 200, etc.), the LN2 cannot be maintained in liquid form at the applicators (e.g. applicators 112, 212). For example, the conduit for transporting the treatment agent from the agent source to the applicators may be above a threshold temperature such that the treatment agent absorbs too much heat while being transported from the agent source to the agent applicators, causing a phase change in at least some of the LN2 during transport. For example, the LN2 may boil off into cold nitrogen gas (i.e. undergo a physical state change) prematurely (e.g. upon being ejected by the applicators), thereby reducing the effectiveness of the treatment agent.

Instead of purging the cold nitrogen gas to the ambient environment as waste, the cold nitrogen gas upon start-up may instead be applied to lower a temperature of the intermediary hopper (e.g. until the temperature of the conduit is sufficiently low such that the LN2 transported from the agent source to the applicators can be maintained at a sufficiently low temperature and remain in liquid form when the treatment agent is applied by the applicators to the aggregate) such that the thermal gradient between the hopper and the treatment agent is lowered. The non-limiting example embodiment is only one example implementation of applying the treatment agent to the hopper in method 300. The treatment agent may be applied to the hopper in any other suitable manner at any suitable step in method 300.

In some embodiments, the treatment agent applied to the intermediary hopper comprises nitrogen gas with a temperature in a range of about −40 degrees Celsius to about 80 degrees Celsius. In some embodiments, the treatment agent applied to the intermediary hopper comprises LN2 in a range of about −150 degrees Celsius to about −200 degrees Celsius.

Method 300 then proceeds to block 303 which comprises the step of measuring one or more properties of the at least one of: the aggregate (e.g. aggregate 106, 206), the treatment agent (e.g. 101, 201), and the intermediary hopper (e.g. 102, 202). In some embodiments, the one or more properties are measured prior to depositing the aggregate into the intermediary hopper.

The one or more properties may include any properties that may have a material impact on the quality of a concrete product produced using the aggregate. In some embodiments, the one or more properties include, but are not limited to, temperature of the aggregate, the treatment agent and/or the intermediary hopper, moisture level of the aggregate, the treatment agent and/or the intermediary hopper, weight of the aggregate to be treated, and types of aggregate materials to be treated, etc.

In some embodiments, the aggregate comprises a plurality of aggregate masses deposited into the intermediary hopper sequentially spaced apart in time as a plurality of batches and block 303 of method 300 is performed for one or more of the plurality of batches.

The measurements may be collected by any suitable sensors and/or devices. In a non-limiting example embodiment, one or more thermometers may be located at various locations to measure temperature of the aggregate, the treatment agent and/or the intermediary hopper. In a non-limiting example embodiment, one or more moisture sensors may be located at various locations to measure a moisture level of the aggregate, the treatment agent, and/or the intermediary hopper. In some embodiments, information regarding the types of aggregate material to be treated may be transmitted as a look-up table by any suitable device to the controller and/or determined by a suitable algorithm based on data obtained by a suitable sensor (e.g. images captured by a camera). In some embodiments, the weight of the aggregate and/or any of the aggregate batches is determined by a suitable weight sensor.

Method 300 then proceeds to block 305 which comprises the step of depositing the aggregate (e.g. aggregate 106, 206) into the intermediary hopper (e.g. intermediary hopper 102, 202). The aggregate may comprise any suitable types of aggregate materials. In some embodiments, the aggregate comprises a plurality of different aggregate materials, e.g., sand, gravels, rocks, etc. The aggregate may be deposited into the intermediary hopper in any suitable manner. In some embodiments, the aggregate comprises a plurality of aggregate masses and at least some of the plurality of aggregate masses is deposited into the intermediary hopper spaced apart in time as one or more batches. The intermediary hopper may comprise any suitable intermediary hopper as described herein (e.g. intermediary hoppers 102, 202).

Method 300 then proceeds to block 307 which comprises the step of controllably applying the treatment agent (e.g. treatment agent 101, 201) to the aggregate (e.g. aggregate 106D, 206D) based on the one or more properties measured at block 303. The controllable application of the treatment agent at block 307 of method 300 may be performed by any suitable controller described herein (e.g. controllers 110, 210). The application of the treatment agent may be controlled in any suitable manner and according to any suitable parameters that may have a material impact on the quality of the concrete produced. In a non-limiting example embodiment, at least one of the following parameters is controlled based on the one or more measured properties:
an amount of treatment agent to be applied;
the type of treatment agent to be applied;
a pressure of the treatment agent to be applied;
a delivery method of the treatment agent;
a droplet size of the treatment to be applied; and,
a spraying pattern of the treatment agent to be applied, etc.

In some embodiments, a pressure of the treatment agent proximate to the agent applicator is measured and the controller is configured to adjust a pressure of the treatment agent at an agent source to achieve a desired pressure of the treatment agent at the agent applicator. The aggregate may be subject to any other suitable treatment and/or manipulation in method 300. For example, in some embodiments, the aggregate may be mixed by a mixing mechanism at any stage subsequent to the deposit of at least some of the aggregate masses into the hopper.

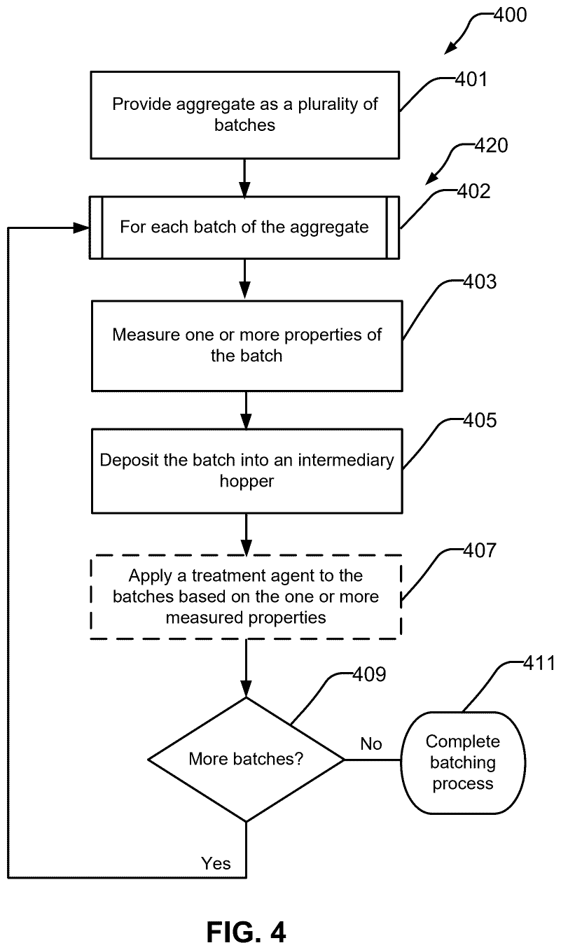

FIG. 4 is a flowchart of a method 400 for treating aggregate for use in a concrete mix according to another example embodiment. Method 400 may be performed by any systems described herein (e.g. systems 100, 200, etc.). Method 400 is similar to method 300 in many aspects. Method 400 may be performed as an iterated sub-routine of steps 303, 305 and 307 of method 300.

Method 400 begins with block 401 which comprises the step of providing aggregate for use in a concrete mixture as a plurality of batches. As described elsewhere herein, a “batch” in this application refers to aggregate mass(es) deposited at a given depositing time. The aggregate may comprise any suitable number of batches. In a non-limiting example embodiment, the number of batches is in a range of about 2 to about 8, and a weight of each batch is in a range of about 200 kg to about 7000 kg.

In some embodiments, the aggregate includes a plurality of different types of aggregate materials. In some embodiments, each batch comprises aggregate material of one type. For example, in a non-limiting example embodiment, the aggregate comprises 20 aggregate masses of which 10 of the aggregate masses comprise sand, 5 of the aggregate masses comprise rocks of about 20 mm diameter, and 5 of the aggregate masses comprise rocks of about 15 mm diameter. It is not necessary that any aggregate mass comprises only aggregate material of one type. In some embodiments, one or more batches comprise two or more types of different aggregate materials.

Method 400 then proceeds to block 402 which begins a sub-routine 420 performed for each of the plurality of batches. Each iteration of sub-routine 420 is performed spaced apart in time.

Sub-routine 420 begins with block 403 which comprises measuring one or more properties of the batch (and optionally one or more properties of an intermediary hopper and/or the treatment agent). Block 403 is similar to block 303. Description related to block 303 also applies to block 403.

Sub-routine 420 then proceeds to block 405 which comprises depositing the batch into an intermediary hopper (e.g. intermediary hopper 102, 202). Block 405 is similar to block 305. Description related to block 305 also applies to block 405 unless indicated otherwise.

Sub-routine 420 then proceeds to optional block 407 which comprises applying the treatment agent (e.g. treatment agent 101, 201) to the batch deposited at block 405 based on the one or more properties measured at block 403. Block 407 is optional because in some cases, it may be determined that no treatment agent needs to be applied to a batch. Block 407 is similar to block 307. Description related to block 307 also applies to block 407.

Sub-routine 420 then reaches a decision step 409 of determining whether there are more batches to be deposited and optionally treated. If there are more batches to be deposited, then sub-routine 420 proceeds down the “Yes” branch and loops back to block 402. If there is no more batch to be deposited, then sub-routine 420 proceeds down the “No” branch and proceeds to block 411 which ends sub-routine 420 and completes the “batching”process.

Systems and methods described herein provide the advantages of achieving superior regulation of one or more properties of the aggregate (e.g., temperature, moisture and/or other parameters) for use in concrete mixture while improving the treatment efficiency (i.e., more efficient use of treatment agent) compared to the state of art by utilizing feedback controlled application of the treatment agent based on one or more measured properties of the aggregate, the treatment agent, and/or the intermediary hopper. The aggregate may also be deposited in a plurality of batches to increase the effective surface area for thermal exchange between the aggregate and the treatment agent.

Where a component (e.g. a software module, processor, assembly, device, circuit, etc.) is referred to herein, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

Embodiments of the invention may be implemented using specifically designed hardware, configurable hardware, programmable data processors configured by the provision of software (which may optionally comprise “firmware”) capable of executing on the data processors, special purpose computers or data processors that are specifically programmed, configured, or constructed to perform one or more steps in a method as explained in detail herein and/or combinations of two or more of these. Examples of specifically designed hardware are: logic circuits, application-specific integrated circuits (“ASICs”), large scale integrated circuits (“LSIs”), very large scale integrated circuits (“VLSIs”), and the like. Examples of configurable hardware are: one or more programmable logic devices such as programmable array logic (“PALs”), programmable logic arrays (“PLAs”), and field programmable gate arrays (“FPGAs”). Examples of programmable data processors are: microprocessors, digital signal processors (“DSPs”), embedded processors, graphics processors, math co-processors, general purpose computers, server computers, cloud computers, mainframe computers, computer workstations, and the like. For example, one or more data processors in a control circuit for a device may implement methods as described herein by executing software instructions in a program memory accessible to the processors.

Processing may be centralized or distributed. Where processing is distributed, information including software and/or data may be kept centrally or distributed. Such information may be exchanged between different functional units by way of a communications network, such as a Local Area Network (LAN), Wide Area Network (WAN), or the Internet, wired or wireless data links, electromagnetic signals, or other data communication channel.

The invention may also be provided in the form of a program product. The program product may comprise any non-transitory medium which carries a set of computer-readable instructions which, when executed by a data processor, cause the data processor to execute a method of the invention. Program products according to the invention may be in any of a wide variety of forms. The program product may comprise, for example, non-transitory media such as magnetic data storage media including floppy diskettes, hard disk drives, optical data storage media including CD ROMs, DVDs, electronic data storage media including ROMs, flash RAM, EPROMs, hardwired or preprogrammed chips (e.g., EEPROM semiconductor chips), nanotechnology memory, or the like. The computer-readable signals on the program product may optionally be compressed or encrypted.

In some embodiments, the invention may be implemented in software. For greater clarity, “software” includes any instructions executed on a processor, and may include (but is not limited to) firmware, resident software, microcode, code for configuring a configurable logic circuit, applications, apps, and the like. Both processing hardware and software may be centralized or distributed (or a combination thereof), in whole or in part, as known to those skilled in the art. For example, software and other modules may be accessible via local memory, via a network, via a browser or other application in a distributed computing context, or via other means suitable for the purposes described above.

Software and other modules may reside on servers, workstations, personal computers, tablet computers, and other devices suitable for the purposes described herein.

### Interpretation of Terms

Unless the context clearly requires otherwise, throughout the description and the claims:
“comprise”, “comprising”, and the like are to be construed in an inclusive sense, as opposed to an exclusive or exhaustive sense; that is to say, in the sense of “including, but not limited to”;
“connected”, “coupled”, or any variant thereof, means any connection or coupling, either direct or indirect, between two or more elements; the coupling or connection between the elements can be physical, logical, or a combination thereof;
“herein”, “above”, “below”, and words of similar import, when used to describe this specification, shall refer to this specification as a whole, and not to any particular portions of this specification;
“or”, in reference to a list of two or more items, covers all of the following interpretations of the word: any of the items in the list, all of the items in the list, and any combination of the items in the list;
the singular forms “a”, “an”, and “the” also include the meaning of any appropriate plural forms. These terms (“a”, “an”, and “the”) mean one or more unless stated otherwise;
“and/or” is used to indicate one or both stated cases may occur, for example A and/or B includes both (A and B) and (A or B);
“approximately” when applied to a numerical value means the numerical value ±10%;
where a feature is described as being “optional” or “optionally” present or described as being present “in some embodiments” it is intended that the present disclosure encompasses embodiments where that feature is present and other embodiments where that feature is not necessarily present and other embodiments where that feature is excluded. Further, where any combination of features is described in this application this statement is intended to serve as antecedent basis for the use of exclusive terminology such as “solely,” “only” and the like in relation to the combination of features as well as the use of “negative” limitation(s)” to exclude the presence of other features; and
“first” and “second” are used for descriptive purposes and cannot be understood as indicating or implying relative importance or indicating the number of indicated technical features.

Words that indicate directions such as “vertical”, “transverse”, “horizontal”, “upward”, “downward”, “forward”, “backward”, “inward”, “outward”, “left”, “right”, “front”, “back”, “top”, “bottom”, “below”, “above”, “under”, and the like, used in this description and any accompanying claims (where present), depend on the specific orientation of the apparatus described and illustrated. The subject matter described herein may assume various alternative orientations. Accordingly, these directional terms are not strictly defined and should not be interpreted narrowly.

Where a range for a value is stated, the stated range includes all sub-ranges of the range. It is intended that the statement of a range supports the value being at an endpoint of the range as well as at any intervening value to the tenth of the unit of the lower limit of the range, as well as any subrange or sets of sub ranges of the range unless the context clearly dictates otherwise or any portion(s) of the stated range is specifically excluded. Where the stated range includes one or both endpoints of the range, ranges excluding either or both of those included endpoints are also included in the invention.

Certain numerical values described herein are preceded by “about”. In this context, “about” provides literal support for the exact numerical value that it precedes, the exact numerical value ±5%, as well as all other numerical values that are near to or approximately equal to that numerical value. Unless otherwise indicated a particular numerical value is included in “about” a specifically recited numerical value where the particular numerical value provides the substantial equivalent of the specifically recited numerical value in the context in which the specifically recited numerical value is presented. For example, a statement that something has the numerical value of “about 10” is to be interpreted as: the set of statements:
in some embodiments the numerical value is 10;
in some embodiments the numerical value is in the range of 9.5 to 10.5;
   and if from the context the person of ordinary skill in the art would understand that values within a certain range are substantially equivalent to 10 because the values with the range would be understood to provide substantially the same result as the value 10 then “about 10” also includes:
in some embodiments the numerical value is in the range of C to D where C and D are respectively lower and upper endpoints of the range that encompasses all of those values that provide a substantial equivalent to the value 10

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

As will be apparent to those of skill in the art upon reading this disclosure, each of the individual embodiments described and illustrated herein has discrete components and features which may be readily separated from or combined with the features of any other described embodiment(s) without departing from the scope of the present invention.

Any aspects described above in reference to apparatus may also apply to methods and vice versa.

Any recited method can be carried out in the order of events recited or in any other order which is logically possible. For example, while processes or blocks are presented in a given order, alternative examples may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, simultaneously or at different times.

Various features are described herein as being present in “some embodiments”. Such features are not mandatory and may not be present in all embodiments. Embodiments of the invention may include zero, any one or any combination of two or more of such features. All possible combinations of such features are contemplated by this disclosure even where such features are shown in different drawings and/or described in different sections or paragraphs. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible). This is the case even if features A and B are illustrated in different drawings and/or mentioned in different paragraphs, sections or sentences.

It is therefore intended that the following appended claims and claims hereafter introduced are interpreted to include all such modifications, permutations, additions, omissions, and sub-combinations as may reasonably be inferred. The scope of the claims should not be limited by the preferred embodiments set forth in the examples, but should be given the broadest interpretation consistent with the description as a whole.

What is claimed is:

1. A system for treating aggregate for use in a concrete mixture, the system comprising:
an intermediary hopper for receiving the aggregate from an aggregate source;
an agent source in fluid communication with the intermediary hopper for applying a treatment agent to the aggregate deposited into the intermediary hopper; and,
a controller in data communication with one or more sensors configured to measure one or more properties of at least one of: the aggregate, the intermediary hopper, and the treatment agent, the controller configured to controllably apply the treatment agent to the aggregate based on one or more control parameters,
wherein the one or more control parameters are based at least on the one or more measured properties.

2. The system of claim 1, wherein the aggregate is deposited into the intermediary hopper spaced apart in time as a plurality of batches and the treatment agent is applied to one or more of the plurality of batches.

3. The system of claim 2, wherein an effective surface area for thermal exchange between the treatment agent and the aggregate deposited as the plurality of batches is greater than an effective surface area for thermal exchange between the treatment agent and the aggregate without batching.

4. The system of claim 1 comprising one or more agent applicators configured to apply the treatment agent to the aggregate wherein the one or more sensors comprise one or more pressure sensors located proximate to the one or more agent applicators for measuring a pressure of the treatment agent, and the controller is configured to adjust a pressure of the treatment agent at the agent source based at least in part on the measured pressure of the treatment agent.

5. The system of claim 1 comprising a plurality of aggregate temperature sensors in data communication with the controller and configured to measure local aggregate temperatures of a plurality of portions of the aggregate at the aggregate source, wherein the controller is configured to selectively and controllably apply the treatment agent to one or more portions of the plurality of portions of the aggregate deposited into the intermediary hopper based at least in part on the measured local aggregate temperatures of the plurality of portions of the aggregate.

6. The system of claim 1 comprising a plurality of aggregate moisture sensors in data communication with the controller and configured to measure local aggregate moisture levels of a plurality of portions of the aggregate at the aggregate source, wherein the controller is configured to selectively and controllably apply the treatment agent to one or more portions of the plurality of portions of the aggregate deposited into the intermediary hopper based at least in part on the measured local aggregate moisture levels of the plurality of portions of the aggregate.

7. The system of claim 1 comprising one or more hopper temperature sensors in data communication with the controller and configured to measure a hopper temperature of the intermediary hopper wherein the controller is configured to apply the treatment agent to the intermediary hopper and/or to at least portions of the aggregate deposited into the intermediary hopper based at least in part on the measured hopper temperature.

8. The system of claim 7, wherein at least some of the treatment agent is applied to the intermediary hopper prior to any aggregate being deposited into the intermediary hopper.

9. The system of claim 7, wherein the treatment agent is applied to the intermediary hopper such that a thermal gradient between the intermediary hopper and the aggregate with the application of the treatment agent to the intermediary hopper is more steep than a thermal gradient between the intermediary hopper and the aggregate without the application of the treatment agent to the intermediary hopper.

10. The system of claim 1, wherein the application of the treatment agent to the aggregate regulates one or more properties of the aggregate, the one or more properties including at least one of: temperature and moisture.

11. The system of claim 1, wherein the treatment agent comprises a specialty gas.

12. The system of claim 11, wherein the specialty gas comprises purified nitrogen gas.

13. The system of claim 1, wherein the treatment agent comprises a cryogenic agent.

14. The system of claim 13, wherein the cryogenic agent comprises liquid nitrogen (LN2).

15. The system of claim 1 wherein the one or more control parameters comprises at least one of: a type of the treatment agent to be applied, a pressure of the treatment agent, a delivery method of the treatment agent, a droplet size of the treatment agent, and a spraying pattern of the treatment agent.

16. The system of claim 1, wherein the aggregate comprises plural portions of different types of aggregate materials and the one or more control parameters is based at least in part on the types of aggregate materials receiving the application of the treatment agent.

17. The system of claim 16, wherein the one or more control parameters is based at least in part on one of: mass, temperature and/or moisture level of the portion of aggregate materials receiving the application of the treatment agent.

18. A method for applying a treatment agent to aggregate to be used in a concrete mixture, the method comprising the steps of:
depositing the aggregate into an intermediary hopper;
measuring one or more properties of at least one of: the aggregate, the treatment agent, and the intermediary hopper; and,
applying the treatment agent to the aggregate according to one or more control parameters, the one or more control parameters based at least in part on the one or more measured properties.

19. A method for treating aggregate to be used in a concrete mixture, the method comprising the steps of:
depositing the aggregate into an intermediary hopper spaced apart in time as a plurality of batches; and,
applying a treatment agent to one or more of the plurality of batches such that an effective surface area for thermal exchange between the treatment agent and the aggregate deposited as the plurality of batches is greater than an effective surface area for thermal exchange between the treatment agent and the aggregate without batching.

20. The method of claim 19 comprising measuring one or more properties of at least some of the plurality of aggregate masses prior to depositing the plurality of aggregate masses into the intermediary hopper, wherein applying the treatment agent to the one or more of the plurality of batches comprises applying the treatment agent to the one or more of the plurality of batches according to one or more control parameters, the one or more control parameters based at least in part on the one or more measured properties.
